(19) United States
(12) Patent Application Publication
(10) Pub. No.: US 2022/0397908 A1
(43) Pub. Date: Dec. 15, 2022

(54) SELF-PROPELLED INSPECTION DEVICE AND EQUIPMENT INSPECTION SYSTEM

(71) Applicant: Hitachi, Ltd., Tokyo (JP)

(72) Inventors: Yuichi IGARASHI, Tokyo (JP); Yuta ESAKA, Tokyo (JP); Kazuo ONO, Tokyo (JP); Noriyasu HASEJIMA, Tokyo (JP); Kazuya MUROTANI, Tokyo (JP); Takehito OGATA, Tokyo (JP)

(21) Appl. No.: 17/775,413

(22) PCT Filed: Jul. 22, 2020
(86) PCT No.: PCT/JP2020/028399

§ 371 Date: May 9, 2022

(30) Foreign Application Priority Data
Dec. 4, 2019 (JP) 2019-219420

(51) Int. Cl. G05D 1/02

(52) U.S. Cl. CPC G05D 1/0274; G05D 1/0255; G05D 2201/0207

(57) ABSTRACT

Provided is a self-propelled inspection device capable of improving efficiency of system introduction cost, setting, and update work necessary for self-propelling in a self-propelled inspection device expected to be operated outdoors for a long period of time. Therefore, there is provided the self-propelled inspection device that autonomously inspects an inspection object while autonomously traveling an inspection route, the self-propelled inspection device including: a self-position estimation unit that estimates a self-position; a map information database that manages map information for autonomous traveling; a traveling unit including a drive mechanism and a steering mechanism; a sensor that senses the inspection object; a map information update unit that updates the map information based on information sensed by the sensor; and a traveling unit control unit that controls the traveling unit based on the updated map information.

### TECHNICAL FIELD

The present invention relates to a self-propelled inspection device and an equipment inspection system suitable for inspection work and maintenance work of equipment and devices installed in a power plant, a substation, or the like.

### BACKGROUND ART

In general inspection work and maintenance work of equipment and devices installed in power plants, substations, chemical plants, various production sites, and the like, workers perform inspection and maintenance at predetermined time intervals according to a predetermined route and inspection plan. More specifically, the worker measures a surface temperature of the equipment to determine whether abnormal overheating has occurred, or reads values such as current and voltage values of the equipment installed in an area to check an operation of the equipment.

It takes a lot of labor for the worker to perform such inspection work, but it is expected that it will be difficult for the worker to continue the inspection work and the like as they are in the future in consideration of an increase in inspection objects due to aging of infrastructure and a decrease in labor population expected in the future. In addition, it is effective to increase frequency of periodic inspection in order to cope with efficient device replacement according to a device state, but the decrease in the working population is making this difficult.

Therefore, a labor-saving technique and an unmanned technique that reduce burden on the worker of the inspection work performed periodically are expected, and a self-propelled inspection device has also been proposed. However, in a site such as a power plant, a floor surface of an inspection route is often not flat, and an obstacle is often present, and thus there are many problems for the inspection device to autonomously travel a predetermined inspection route.

In response to this problem, in a self-propelled inspection device described in PTL 1, when the self-propelled inspection device reaches an area where it is difficult for the self-propelled inspection device to travel or an area where self-position estimation accuracy of the self-propelled inspection device decreases, an auxiliary signal (beacon or communication) is used as a trigger for the self-propelled inspection device to switch to a self-position estimation function suitable for the area, so that autonomous traveling can be continued. In the autonomous traveling of the inspection device, it is important to maintain the self-position estimation accuracy high, and in PTL 1, it is possible to automatically perform the inspection work of the indoor production facility by accurately giving the auxiliary signal.

### CITATION LIST

### Patent Literature

PTL 1: JP 6011562 B2

### SUMMARY OF INVENTION

### Technical Problem

However, in PTL 1, since the self-propelled inspection device is caused to self-propel based on static map information that does not reflect an environmental change, in a case where a traveling environment dynamically changes outdoors, or in a case where the self-position estimation accuracy changes depending on time or place, automatic traveling may be difficult. In order to avoid this, it is possible to spread the auxiliary signal over the entire inspection area in advance and generate the auxiliary signal according to the environment, but the number of auxiliary signal generation devices increases and the introduction cost of the system increases.

Therefore, it is important to be able to maintain the self-position estimation accuracy high even in an area where the environment (state of floor surface, signal intensity of GPS or the like for estimating self-position, plant inhibiting automatic travel, or the like) of the inspection area changes.

The present invention has been made in view of the above-described problems, and an object of the present invention is to provide a self-propelled inspection device and an equipment inspection system capable of improving efficiency of system introduction cost, setting, and update work necessary for self-propelling in a self-propelled inspection device expected to be operated outdoors for a long period of time.

### Solution to Problem

In order to solve the above problems, a self-propelled inspection device of the present invention is a device that autonomously inspects an inspection object while autonomously traveling an inspection route, the self-propelled inspection device including: a self-position estimation unit that estimates a self-position; a map information database that manages map information for autonomous traveling; a traveling unit including a drive mechanism and a steering mechanism; a sensor that senses the inspection object; a map information update unit that updates the map information based on information sensed by the sensor; and a traveling unit control unit that controls the traveling unit based on the updated map information.

### Advantageous Effects of Invention

According to the self-propelled inspection device and the equipment inspection system of the present invention, by using history information of an equipment inspection result continuously and periodically collected, it is possible to generate and update information dynamically changing in an inspection site necessary for autonomous traveling and the map auxiliary information that compensates for self-position estimation accuracy and is for a self-propelled path, and to reduce system introduction and update cost for long-term outdoor operation.

### BRIEF DESCRIPTION OF DRAWINGS

FIG. 1 is a schematic explanatory diagram of an equipment inspection system according to an embodiment.

FIG. 2 is a functional block diagram of a self-propelled inspection device according to the embodiment.

FIG. 3A is a GUI configuration diagram displayed on a display unit.

FIG. 3B is an example of a map information display unit displayed on a GUI of FIG. 3A.

FIG. 3C is an example of an auxiliary information display unit displayed on the GUI of FIG. 3A.

FIG. 4 is a flowchart of generation and management of auxiliary information.

FIG. 5 is a flowchart illustrating map information update processing.

FIG. 6 is a flowchart illustrating travel path creation processing.

FIG. 7 is a flowchart illustrating auxiliary information generation/update processing.

### DESCRIPTION OF EMBODIMENTS

A self-propelled inspection device of the present invention is an inspection device that has a function of creating and updating a map for autonomous traveling, and autonomously travels by using the created map, the self-propelled inspection device having a function of creating and updating supplementary information to the map for traveling based on traveling auxiliary information in places where self-position estimation is difficult, for example, information of a camera image and various sensors acquired for equipment inspection at a place (an area where similar walls and roads continue) where self-position accuracy and reliability deteriorate in a simultaneously localization and mapping (SLAM) technology, and further including a travel path management device that displays and corrects the auxiliary information. Hereinafter, the self-propelled inspection device of the present invention will be described in detail with reference to the drawings.

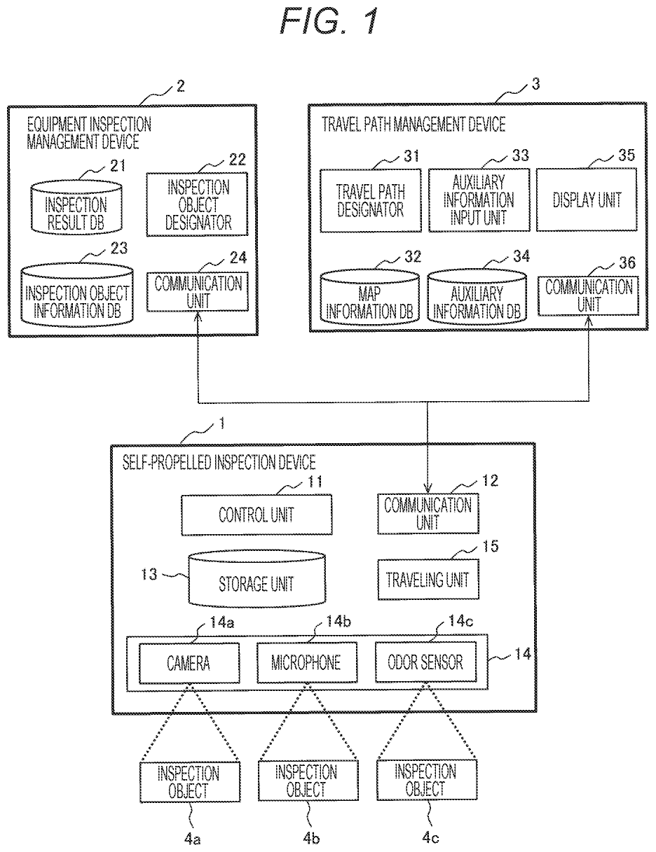

FIG. 1 is a diagram illustrating an overall configuration of an equipment inspection system according to an embodiment of the present invention. As illustrated here, the equipment inspection system of the present embodiment mainly includes a self-propelled inspection device 1, an equipment inspection management device 2, and a travel path management device 3. Then, the self-propelled inspection device 1 inspects inspection objects 4 (4a to 4c) such as equipment and devices while autonomously traveling on a prescribed inspection route of a power plant, a substation, or the like. The inspection object 4 is, for example, an ammeter, a voltmeter, an oil level gauge, a transformer, a motor, a hydraulic device, or the like, and the self-propelled inspection device 1 inspects a current value, a voltage value, an oil level, an operating sound level, presence or absence of oil leakage, and the like, and manages and accumulates inspection results. Note that FIG. 1 illustrates a configuration in which the equipment inspection management device 2 and the travel path management device 3 are separated from each other, but they may be integrated with each other. Hereinafter, each device will be sequentially described in detail.

<Equipment Inspection Management Device 2>

As illustrated in FIG. 1, the equipment inspection management device 2 includes an inspection result database that accumulates inspection results of the inspection object 4, an inspection object designator 22 used to designate the inspection object 4 from among a large number of equipment and devices present at a site, an inspection object information database 23 that manages an installation place, an installation height, a type, and the like of the inspection object, and a communication unit 24 that shares both databases with the self-propelled inspection device 1.

<Travel Path Management Device 3>

As illustrated in FIG. 1, the travel path management device 3 includes a travel path designator 31, a map information database 32, an auxiliary information input unit 33, an auxiliary information database 34, a display unit 35, and a communication unit 36.

The travel path designator 31 designates a route on which the self-propelled inspection device 1 inspects the site. The map information database 32 manages map information of the site prepared in advance and an inspection route designated by the travel path designator 31. Note that the map information of the site is, for example, the map information in which the position and shape of a building and the position and shape of a passage are registered in XML format or the like. The auxiliary information input unit 33 inputs auxiliary information that is not described in the map information prepared in advance but is necessary for self-propelling at the site. The auxiliary information is, for example, a width and a length of a side groove under a wall of the building, or information that is difficult to acquire when the self-propelled inspection device 1 performs self-position estimation, for example, a size and an orientation of the wall in an environment where a similar wall continues for a while. The auxiliary information database 34 stores the information input from the auxiliary information input unit 33. The display unit 35 is a display device used when the inspection route is designated using the travel path designator 31 or when the auxiliary information is input using the auxiliary information input unit 33, and can display the map information registered in the map information database 32 or the auxiliary information registered in the auxiliary information database 34. Note that details of a graphical user interface (GUI) displayed on the display unit 35 will be described later. The communication unit 36 is a unit for sharing the map information database 32 and the auxiliary information database 34 with the self-propelled inspection device 1.

<Self-Propelled Inspection Device 1>

As illustrated in FIG. 1, the self-propelled inspection device 1 includes a control unit 11, a communication unit 12, a storage unit 13, a sensor unit 14, and a traveling unit 15.

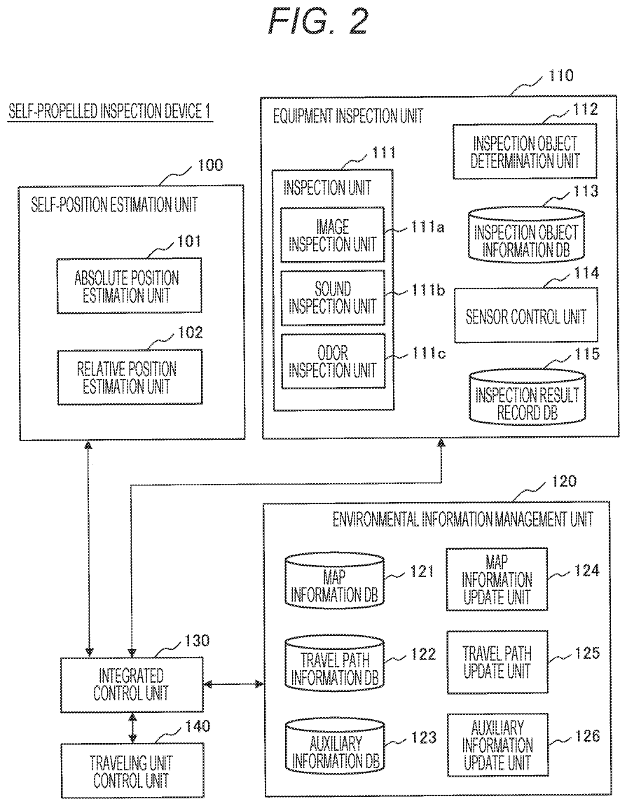

The control unit 11 is a unit that integrally manages other units in the self-propelled inspection device 1, and is specifically a computer including an arithmetic device such as a CPU, a storage device such as a semiconductor memory, and the like. Then, the arithmetic device executes a program read into a main storage device to implement functions described in FIG. 2 and the like.

The communication unit 12 is an interface used for sharing information with the equipment inspection management device 2 and the travel path management device 3. Note that information sharing is preferably performed in real time using a wireless communication network such as a mobile phone network, but it is not always necessary to share information in real time, and the information sharing may be performed as batch processing when the communication unit of each device is connected by wire or by interposing a detachable storage medium in each device.

The storage unit 13 is a unit that accumulates inspection object information, travel path information, and the like acquired via the communication unit 12 from the inspection result database 21 and the inspection object information database 23 of the equipment inspection management device 2 or the map information database 32 and the auxiliary information database 34 of the travel path management device 3.

The sensor unit 14 is a unit including a plurality of sensors for sensing the inspection object 4, and FIG. 1 illustrates a configuration including a camera 14a, a microphone 14b, and an odor sensor 14c. The camera 14a is a sensor that captures an image of the inspection object 4a that needs to view measurement values of the ammeter, the voltmeter, the oil level gauge, or the like, and angle and focus of the camera 14a are controlled by the control unit 11. The microphone 14b is a sensor that records an operating sound of the inspection object 4b that emits a sound of the transformer, the motor, or the like. The odor sensor 14c is a sensor that detects an odor of the inspection object 4c that emits the odor at an abnormal time like the hydraulic device that has leaked oil. Note that a type of the sensor is not limited to those illustrated in FIG. 1, and various sensors for inspecting temperature, an amount of salt in the air, and the like may be added.

The traveling unit 15 is a unit including a drive mechanism and a steering mechanism, and can cause the self-propelled inspection device 1 to travel on a predetermined inspection route by the control unit 11 controlling both the mechanisms according to the travel path information.

Next, functional blocks of the self-propelled inspection device 1 mainly realized by the control unit 11 and the storage unit 13 will be described with reference to a functional block diagram of FIG. 2. As illustrated herein, the functional blocks of the self-propelled inspection device 1 are roughly divided into a self-position estimation unit 100, an equipment inspection unit 110, an environmental information management unit 120, an integrated control unit 130, and a traveling unit control unit 140.

The self-position estimation unit 100 is a functional block for estimating a current position of the self-propelled inspection device 1, and includes an absolute position estimation unit 101 and a relative position estimation unit 102. The absolute position estimation unit 101 estimates an absolute position at the site by, for example, collating the satellite navigation system (GPS) information and the map information with an output of a laser scanner camera. The relative position estimation unit 102 estimates a relative position at the site by calculating a movement amount from a known absolute position using a tracking camera or an acceleration sensor. Further, the relative position estimation unit 102 can also estimate a distance to the inspection object by comparing the operating sound level and the odor level of the inspection object managed as the auxiliary information with the actually detected operating sound level and odor level.

The equipment inspection unit 110 is a functional block for performing equipment inspection based on the output of the sensor unit 14, and includes an inspection unit 111, an inspection object determination unit 112, an inspection object information database 113, a sensor control unit 114, and an inspection result record database 115. The inspection unit 111 further includes an image inspection unit 111a that performs inspection based on the output of the camera 14a, a sound inspection unit 111b that performs inspection based on the output of the microphone 14b, and an odor inspection unit 111c that performs inspection based on the output of the odor sensor 14c.

The inspection object determination unit 112 determines the presence or absence of the inspection object 4 in the vicinity of the self-propelled inspection device 1 from a relationship between the position information and the type information of the inspection object 4 read from the inspection object information database 113 and current position information estimated by the self-position estimation unit 100. When it is determined that there is the inspection object 4 in the vicinity, the sensor control unit 114 controls the sensor such as the camera 14a according to the direction, distance, and type of the inspection object 4, and the inspection unit 111 performs appropriate inspection processing on the output of the camera 14a and the like. The inspection result record database 115 stores inspection results of the inspection unit 111.

The environmental information management unit 120 is a functional block for managing environmental information necessary for the self-propelled inspection device 1 to autonomously travel at the site, and includes a map information database 121, a travel path information database 122, an auxiliary information database 123, a map information update unit 124, a travel path update unit 125, and an auxiliary information update unit 126. The map information database 121 and the travel path information database 122 basically store the map information and the travel path information acquired from the map information database 32 of the travel path management device 3, and the auxiliary information database 123 basically stores the auxiliary information acquired from the auxiliary information database 34 of the travel path management device 3.

However, each update unit can update each database based on the inspection result acquired from the equipment inspection unit 110 during site inspection. For example, when a new obstacle is detected or removal of a known obstacle is detected from a captured image of the camera 14a photographing the surroundings of the self-propelled inspection device 1, the map information update unit 124 updates the map information of the map information database 121, and the travel path update unit 125 generates a travel path for avoiding the new obstacle or a travel path passing through the passage having the removed obstacle as necessary. Further, when a step on the road surface is newly detected from the captured image of the camera 14a, when a characteristic sound is newly detected from a recording of the microphone 14b, or when a characteristic odor is newly detected from the output of the odor sensor 14c, the auxiliary information update unit 126 registers it in the auxiliary information database 123 as new auxiliary information together with the detection position. These pieces of auxiliary information are information that can be used to estimate the current position when the self-propelled inspection device 1 passes through the same place next time, and the self-position estimation can be corrected by estimating the distance to the inspection object 4 that emits the sound or odor from intensity of the characteristic sound or odor.

<Example of GUI of Display Unit 35>

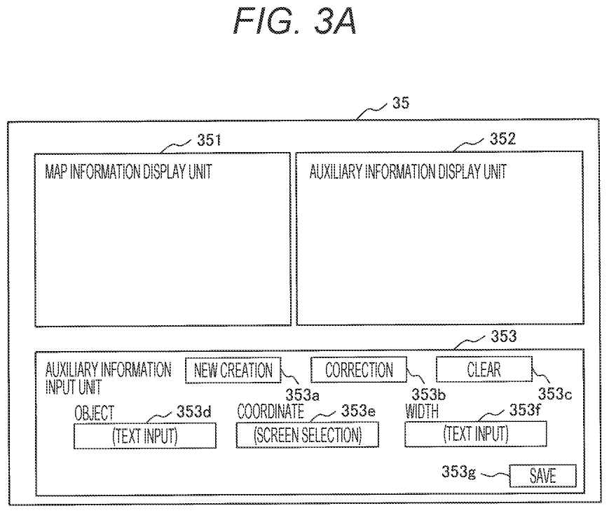

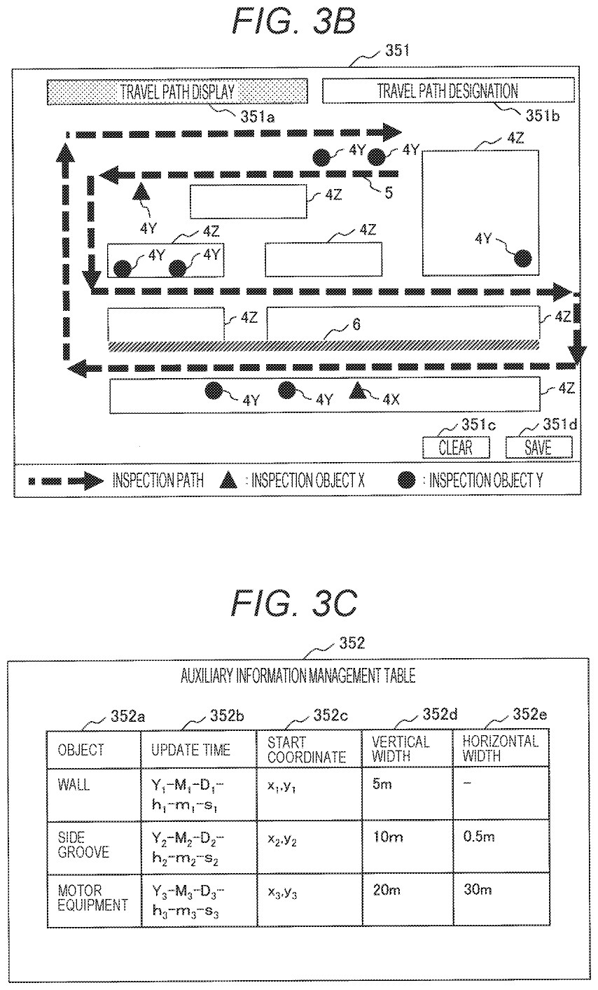

FIG. 3A is an example of the GUI displayed on the display unit 35 when a worker operates the travel path management device 3, and includes a map information display unit 351, an auxiliary information display unit 352, and an auxiliary information input unit 353.

As illustrated in FIG. 3B, the map information display unit 351 has in an upper portion a travel path display button 351a to be pressed when displaying the travel path, and a travel path designation button 351b to be pressed when transitioning to an edit mode of the travel path, has in a lower portion a clear button 351c to be pressed when deleting an existing travel path, and a save button 351d to be pressed when saving an edited travel path, and further has in the center a region for displaying the travel path and the like in the site.

First, when the worker presses the travel path display button 351a, an existing inspection path 5 on which the self-propelled inspection device 1 travels, inspection objects 4X and 4Y, an inspection area 4Z, and auxiliary information 6 (presence or absence of side groove, position and shape of side groove, material of passage, and the like) near the inspection path 5 are displayed. Note that different signs of the inspection object 4X and the inspection object 4Y indicate that the types of sensors used for the inspection are different.

When the worker presses the travel path designation button 351b to shift to the edit mode, the existing inspection path 5 can be erased by pressing the clear button 351c. Further, the operator can update the inspection path 5 by operating a mouse or the like to draw a new inspection path 5 and then pressing the save button 351d. For example, when it is known in advance that the new obstacle is to be provided on the existing inspection path 5 due to planned construction or the like, the worker can reset an appropriate inspection path 5 avoiding the new obstacle by using the above-described procedure, and the self-propelled inspection device 1 can continue smooth inspection according to the reset inspection path 5.

Even when the necessity of correction of the auxiliary information is known in advance due to the planned construction or the like, the worker can update the auxiliary information by using the auxiliary information input unit 353 in FIG. 3A. For example, when the auxiliary information is newly created, a new creation button 353a is pressed, when the auxiliary information is corrected, a correction button 353b is pressed, and when the auxiliary information is deleted, a clear button 353c is pressed. Further, after desired data is input to each of an object field 353d, a coordinate field 353e, and a width field 353f, an update of the auxiliary information can be saved by pressing a save button 353g.

FIG. 3C is an example of an auxiliary information management table displayed on the auxiliary information display unit 352. As illustrated herein, the auxiliary information management table includes an object field 352a for registering the type of the object of the auxiliary information, an update time field 352b for registering a creation time and an update time of the auxiliary information, a start coordinate field 352c for registering start coordinates of the auxiliary information, a vertical width field 352d for registering a vertical width, a horizontal width field 352e for registering a horizontal width, and the like. By registering the start coordinates, the vertical width, and the horizontal width of the auxiliary information in this table, it is possible to reflect the position, the size, and the like of the side groove known in advance in the map information as exemplified in the auxiliary information 6 of FIG. 3B.

<Equipment Inspection by Equipment Inspection System>

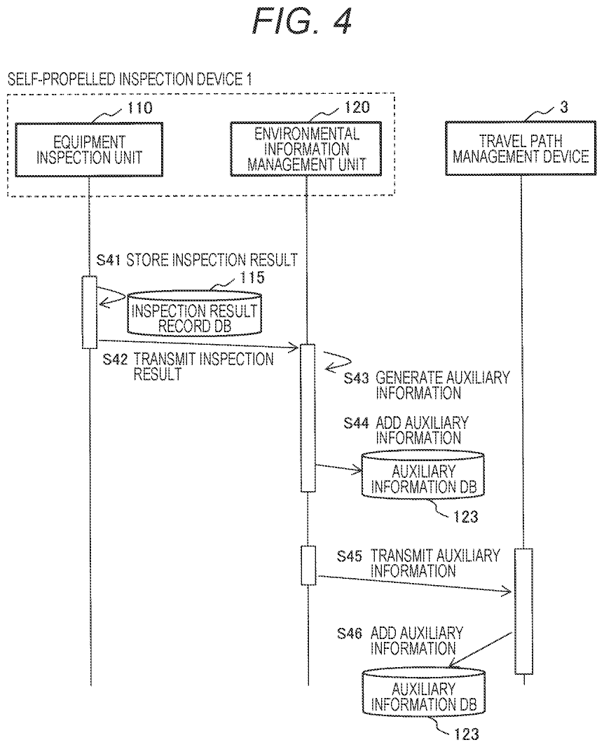

Next, an operation of the equipment inspection of the equipment inspection system of the present embodiment will be described with reference to FIG. 4. Here, it is assumed that various types of information in the databases of the equipment inspection management device 2 and the travel path management device 3 are read in the storage unit 13 of the self-propelled inspection device 1.

When the self-propelled inspection device 1 starts the inspection along the inspection path 5 and the equipment inspection unit 110 obtains a predetermined inspection result, the inspection result is stored in the inspection result record database 115 (step S41). In addition, the equipment inspection unit 110 transmits the inspection result to the environmental information management unit 120 (step S42).

For example, when detecting the new obstacle or the like from the inspection result, the environmental information management unit 120 that has received the inspection result generates the new auxiliary information (step S43) and registers the new auxiliary information in the auxiliary information database 123 (step S44). Thereafter, the environmental information management unit 120 transmits the new auxiliary information to the travel path management device 3 (step S45), and the travel path management device 3 that has received the new auxiliary information adds the new auxiliary information to the auxiliary information database 34. Thus, since the auxiliary information database of the self-propelled inspection device 1 and the travel path management device 3 are synchronized with each other, backup data of the self-propelled inspection device 1 is stored in the travel path management device 3. In addition, even when another self-propelled inspection device performs the inspection, the inspection can be performed based on the new auxiliary information acquired from the travel path management device 3.

<Map Information Update Processing>

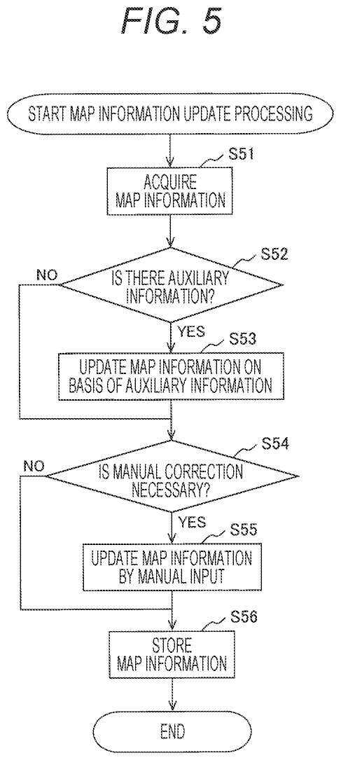

Next, map information update processing by the map information update unit 124 will be mainly described with reference to a flowchart of FIG. 5.

First, in step S51, the map information update unit 124 acquires the map information from the map information database 121. Next, in step S52, the map information update unit 124 determines whether there is new auxiliary information detected during the inspection. Then, if there is the new auxiliary information, the process proceeds to step S53, and if not, the process proceeds to step S54.

In step S53, the map information update unit 124 updates the map information based on the new auxiliary information (for example, the new obstacle).

On the other hand, in step S54, the map information update unit 124 determines whether it is necessary to manually correct the map information. Then, if manual correction is necessary, the process proceeds to step S55, and if not, the process proceeds to step S56.

In step S55, the map information update unit 124 receives correction of the map information by manual input (for example, the new obstacle which is known in advance by a construction plan), and updates the map information.

Finally, in step S56, the map information update unit 124 stores the map information in the map information database 121. Note that although not illustrated in FIG. 5, when the map information in the map information database 121 is updated, the map information in the map information database 32 of the travel path management device 3 is also updated.

<Travel Path Update Processing and Auxiliary Information Update Processing>

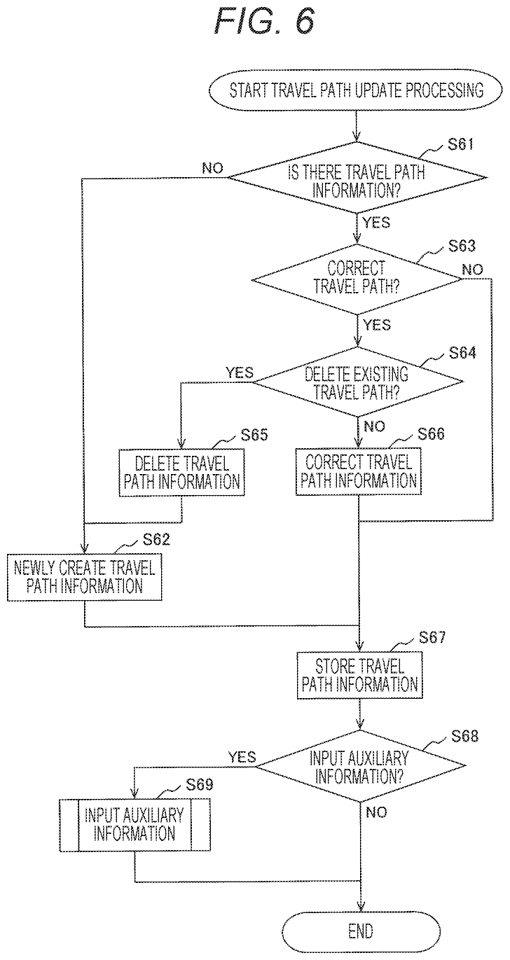

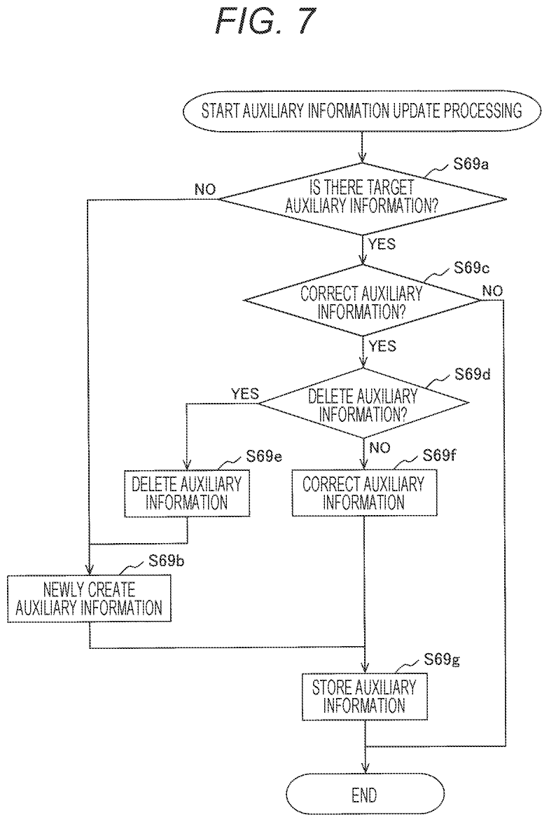

Next, travel path update processing by the travel path update unit 125 and auxiliary information update processing by the auxiliary information update unit 126 will be mainly described with reference to flowcharts of FIGS. 6 and 7.

First, in step S61, the travel path update unit 125 determines whether the travel path information is registered in the travel path information database 122. Then, if there is the travel path information, the process proceeds to step S63, and if not, the process proceeds to step S62.

In step S62, the travel path update unit 125 newly creates appropriate travel path information in consideration of the map information of the site registered in the map information database 121, positions of the inspection objects 4X and 4Y at the site, and arrangement of the inspection area 4Z.

On the other hand, in step S63, the travel path update unit 125 determines whether to correct the travel path information registered in the travel path information database 122. Note that a case of correcting the travel path information is, for example, a case where existing travel path information cannot be used, such as a case where the number of inspection objects increases or a case where an obstacle occurs on the existing travel path. Then, if the travel path information is to be corrected, the process proceeds to step S64, and if not, the process proceeds to step S67.

In step S64, the travel path update unit 125 determines whether to delete the existing travel path information. Note that a case of deleting the travel path information is, for example, a case where it is necessary to significantly change the travel path information, and it is rather inefficient to perform correction processing by diverting the existing travel path information. Then, if the travel path information is to be deleted, the process proceeds to step S65, and if not, the process proceeds to step S66.

In step S65, the travel path update unit 125 deletes the existing travel path information. Thereafter, step S62 described above is performed, and the appropriate travel path information is generated.

On the other hand, in step S66, the travel path update unit 125 generates the appropriate travel path information in consideration of the new inspection object 4 and the like based on the existing travel path information.

In step S67, the travel path update unit 125 stores the travel path information newly created in step S62 or the travel path information corrected in step S66 in the travel path information database 122. Note that although not illustrated in FIG. 6, when the travel path information in the travel path information database 122 is updated, the travel path information in the map information database 32 of the travel path management device 3 is also updated.

In step S68, the auxiliary information update unit 126 determines whether to input the auxiliary information. Then, if the auxiliary information is to be input, the process proceeds to step S69, and if not, the processing ends.

Here, details of step S69 will be described with reference to FIG. 7.

First, in step S69a, the auxiliary information update unit 126 determines whether there is auxiliary information for the current site. Then, if there is the auxiliary information, the process proceeds to step S69c, and if not, the process proceeds to step S69b.

In step S69b, the auxiliary information update unit 126 newly creates the auxiliary information for the current site.

On the other hand, in step S69c, the integrated control unit 130 determines whether to correct the auxiliary information. Then, if the auxiliary information is to be corrected, the process proceeds to step S69d, and if not, the processing ends.

In step S69d, the auxiliary information update unit 126 determines whether to delete the existing auxiliary information. Note that a case of deleting the auxiliary information is, for example, a case where it is necessary to significantly change the auxiliary information, and it is rather inefficient to perform correction processing by diverting the existing auxiliary information. Then, if the auxiliary information is to be deleted, the process proceeds to step S69e, and if not, the process proceeds to step S69f.

In step S69e, after deleting the existing auxiliary information, the auxiliary information update unit 126 performs step S69b described above and generates appropriate auxiliary information.

On the other hand, in step S69f, the auxiliary information update unit 126 generates the appropriate auxiliary information in consideration of the new obstacle and the like based on the existing auxiliary information.

In step S69g, the auxiliary information update unit 126 stores the auxiliary information newly created in step S69b or the auxiliary information corrected in step S69f in the auxiliary information database 123. Note that although not illustrated in FIG. 7, when the auxiliary information in the auxiliary information database 123 is updated, the auxiliary information in the auxiliary information database 34 of the travel path management device 3 is also updated.

According to the self-propelled inspection device and the equipment inspection system of the present embodiment described above, by using history information of an equipment inspection result continuously and periodically collected, it is possible to generate and update information dynamically changing in an inspection site necessary for autonomous traveling and the map auxiliary information that compensates for self-position estimation accuracy and is for a self-propelled path, and to reduce system introduction and update cost for long-term outdoor operation.

### REFERENCE SIGNS LIST

1 self-propelled inspection device
11 control unit
12 communication unit
13 storage unit
14 sensor unit
14a camera
14b microphone
14c odor sensor
100 self-position estimation unit
101 absolute position estimation unit
102 relative position estimation unit
110 equipment inspection unit
111 inspection unit
111a image inspection unit
111b sound inspection unit
111c odor inspection unit
112 inspection object determination unit
113 inspection object information database
114 sensor control unit
115 inspection result record database
120 environmental information management unit
121 map information database
122 travel path information database
123 auxiliary information database
124 map information update unit
125 travel path update unit
126 auxiliary information update unit
130 integrated control unit
140 traveling unit control unit
2 equipment inspection management device
21 inspection result database
22 inspection object designator
23 inspection object information database
24 communication unit
3 travel path management device
31 travel path designator
32 map information database
33 auxiliary information input unit
34 auxiliary information database
35 display unit
351 map information display unit
352 auxiliary information display unit
353 auxiliary information input unit
4, 4a, 4b, 4X, 4Y inspection object
4Z inspection area
5 inspection path
6 auxiliary information

1.-8. (canceled)

9. A self-propelled inspection device that autonomously inspects an inspection object while autonomously traveling an inspection route, the self-propelled inspection device comprising:
a self-position estimation unit that estimates a self-position;
a map information database that manages map information for autonomous traveling;
a traveling unit including a drive mechanism and a steering mechanism;
a sensor that senses the inspection object;
a map information update unit that updates the map information based on information sensed by the sensor;
a traveling unit control unit that controls the traveling unit based on the updated map information;
an auxiliary information database that manages auxiliary information for assisting the map information; and
an auxiliary information update unit that updates the auxiliary information based on the information sensed by the sensor, wherein
an operating sound level of the inspection object that emits a sound is registered in the auxiliary information, and
the self-position estimation unit compares the operating sound level registered in the auxiliary information with a sound level detected by the sensor, to estimate a distance to the inspection object.

10. The self-propelled inspection device according to claim 9, further comprising:
a travel path information database that manages travel path information indicating the inspection route; and
a travel path update unit that updates the travel path information based on the information sensed by the sensor.

11. The self-propelled inspection device according to claim 9, further comprising
an inspection object information database that manages inspection object information including position information and type information of the inspection object, wherein
the sensor is controlled based on a relative direction or a relative distance calculated from the self-position estimated by the self-position estimation unit and a position of the inspection object managed by the inspection object information.

12. The self-propelled inspection device according to claim 9, wherein
the map information manages a position and a shape of a building and a position and a shape of a passage, and the auxiliary information manages a position and a shape of a wall, a position and a shape of a groove, or a material of the passage, which are not managed by the map information.

13. The self-propelled inspection device according to claim 9, wherein
an odor level of the inspection object that emits an odor is registered in the auxiliary information, and
the self-position estimation unit compares the odor level registered in the auxiliary information with an odor level detected by the sensor to estimate a distance to the inspection object.

14. An equipment inspection system comprising:
a self-propelled inspection device that autonomously inspects an inspection object while autonomously traveling an inspection route;
an equipment inspection management device that manages the inspection object; and
a travel path management device that manages the inspection route,
wherein
the self-propelled inspection device comprises:
a self-position estimation unit that estimates a self-position;
a map information database that manages map information for autonomous traveling;
a traveling unit including a drive mechanism and a steering mechanism;
a sensor that senses the inspection object;
a map information update unit that updates the map information based on information sensed by the sensor;
a traveling unit control unit that controls the traveling unit based on the updated map information;
an auxiliary information database that manages auxiliary information for assisting the map information; and
an auxiliary information update unit that updates the auxiliary information based on the information sensed by the sensor, wherein
an operating sound level of the inspection object that emits a sound is registered in the auxiliary information and the self-position estimation unit compares the operating sound level registered in the auxiliary information with a sound level detected by the sensor to estimate a distance to the inspection object, and
the map information updated by the map information update unit is reflected in the travel path management device.

15. The self-propelled inspection device according to claim 9, wherein
the map information update unit updates map information in the map information database from an image captured by a camera that photographs surroundings of the self-propelled inspection device.
